(19) United States
(12) Patent Application Publication
(10) Pub. No.: US 2008/0155718 A1
(43) Pub. Date: Jun. 26, 2008

(54) System and method for taking out medicines

(75) Inventor: Joon Ho Kim, Daegu (KR)

Correspondence Address: SEED INTELLECTUAL PROPERTY LAW GROUP PLLC, 701 FIFTH AVE, SUITE 5400, SEATTLE, WA, 98104, US

(73) Assignee: JVM Co., Ltd., Daegu (KR)

(21) Appl. No.: 11/725,984

(22) Filed: Mar. 19, 2007

(30) Foreign Application Priority Data
Dec. 21, 2006 (KR) 10-2006-0132096

(51) Int. Cl. B25J 11/00

(52) U.S. Cl. 901/1

(57) ABSTRACT

The present invention relates to a system and method for taking out medicines, wherein a robot unit is used to take out a medicine, which corresponds to medicine information received from a medicine information providing unit, from a medicine storage unit and to move the medicine to a predetermined position, so that a pharmacist can be conveniently provided with the medicine to be used for preparation. To this end, a system for taking out medicines according to the present invention comprises a medicine storage unit for storing medicines; a medicine information providing unit for transmitting at least one piece of medicine information; a storage portion for storing medicine information on the medicines stored in the medicine storage unit as well as position information on the medicines; and a robot unit for taking out a corresponding medicine from the medicine storage unit and moving the taken-out medicine to a predetermined position if the storage portion has stored medicine information which is identical to medicine information received from the medicine information providing unit.

### BACKGROUND OF THE INVENTION

1. Field of the Invention

The present invention relates to a system and method for taking out medicines, and more particularly, to a system and method for taking out medicines, wherein a robot unit is used to take out a medicine, which corresponds to medicine information received from a medicine information providing unit, from a medicine storage unit and to move the medicine to a predetermined position, so that a pharmacist can be conveniently provided with the medicine to be used for preparation.

2. Description of the Related Art

Generally, an automatic medicine packing apparatus is an apparatus which is equipped in a hospital or pharmacy to automatically pack medicines as a dose dispensed by a pharmacist according to each prescription.

Such an automatic medicine packing apparatus automatically discharges the medicines prescribed according to respective diseases of patients, and then packs the discharged medicines dose by dose. The automatic medicine packing apparatus is designed so that a plurality of medicine cassettes, which have various medicines, respectively, are arranged in and mounted to a plurality of cassette supports (hereinafter, referred to be “cartridges”), the medicine cassettes mounted to the cartridges are intermittently controlled, respectively, the medicines prescribed dose by dose are discharged downwards through respective passages formed in the cartridges, the medicines discharged from the cartridges are collected to a hopper, and the medicines collected to the hopper are discharged to the bottom side of the hopper and thus tightly packed by packing means and packing paper.

However, contrary to the preparation of medicines using the automatic medicine packing unit for packing medicines dosage by dosage, if there is a prescription on a medicine that has not been held in the cassettes of the automatic medicine packing unit, there is a disadvantage in that a pharmacist should directly find the corresponding medicine to be used for preparation.

Furthermore, since various kinds of medicines are displayed in a pharmacy and the number of medicines is considerable, there is another disadvantage in that it takes a great deal of time to find medicines described in a prescription.

### BRIEF SUMMARY OF THE INVENTION

An object of the present invention is to provide a system and method for taking out medicines, wherein a robot unit is used to take out a medicine, which corresponds to medicine information received from a medicine information providing unit, from a medicine storage unit and to move the medicine to a predetermined position, so that a pharmacist can be conveniently provided with the medicine to be used for preparation.

According to an aspect of the present invention for achieving the object, there is provided a system for taking out medicines, comprising a medicine storage unit for storing medicines; a medicine information providing unit for transmitting at least one piece of medicine information; a storage portion for storing medicine information on the medicines stored in the medicine storage unit as well as position information on the medicines; and a robot unit for taking out a corresponding medicine from the medicine storage unit and moving the taken-out medicine to a predetermined position if the storage portion has stored medicine information which is identical to medicine information received from the medicine information providing unit.

The robot unit may include a reception processing portion for receiving the medicine information from the medicine information providing unit; a first decision portion for determining whether the storage portion has stored the medicine information which is identical to the received medicine information; a detection portion for detecting position information on the corresponding medicine from the storage portion if it is determined that the storage portion has stored the medicine information which is identical to the received medicine information; and an operation portion for moving the robot unit to the detected position to take out the corresponding medicine.

Bar codes for representing medicine information may be attached to the medicines stored in the medicine storage unit, and the robot unit may further include a bar code reading portion for reading the bar code attached to the corresponding medicine; and a second decision portion for determining whether the received medicine information is identical to medicine information of the read bar code.

The robot unit may further include a transmission processing portion for transmitting an error message to the medicine information providing unit if the storage portion does not store medicine information which is identical to the received medicine information.

According to another aspect of the present invention, there is provided a method for taking out medicines in a system for taking out medicines including a medicine storage unit for storing medicines, a medicine information providing unit for transmitting at least one piece of medicine information, and a robot unit for receiving medicine information from the medicine information providing unit and taking out medicines from the medicine storage unit, wherein the method comprises the steps of receiving the medicine information from the medicine information providing unit; determining whether a storage portion has stored the received medicine information; if it is determined that the storage portion has stored the medicine information which is identical to the received medicine information, detecting position information on a corresponding medicine from the storage portion; moving the robot unit to the detected position and taking out the corresponding medicine; and moving the taken-out medicine to a predetermined position.

Bar codes for representing medicine information may be attached to the medicines stored in the medicine storage unit, and the method may further comprise, after the detecting step, the steps of moving the robot unit to the detected position and reading the bar code attached to the corresponding medicines, and determining whether the received medicine information is identical to the medicine information of the read bar code.

After the determining step, the method may further comprise the step of, if the storage portion does not have stored medicine information which is identical to the received medicine information, transmitting an error message to the medicine information providing unit.

### BRIEF DESCRIPTION OF THE SEVERAL VIEWS OF THE DRAWINGS

The above and other objects, features and advantages of the present invention will become apparent from the following description of preferred embodiments given in conjunction with the accompanying drawings, in which:

FIG. 1 is a block diagram illustrating a system for taking out medicines according to an embodiment of the present invention;

FIG. 2 is a block diagram illustrating a medicine information providing unit shown in FIG. 1;

FIG. 3 is a block diagram illustrating a robot unit shown in FIG. 1; and

FIG. 4 is a flowchart illustrating a method for taking out medicines in the system for taking out medicines according to another embodiment of the present invention.

### DETAILED DESCRIPTION OF THE INVENTION

Hereinafter, preferred embodiments of the present invention will be described in detail with reference to the accompanying drawings.

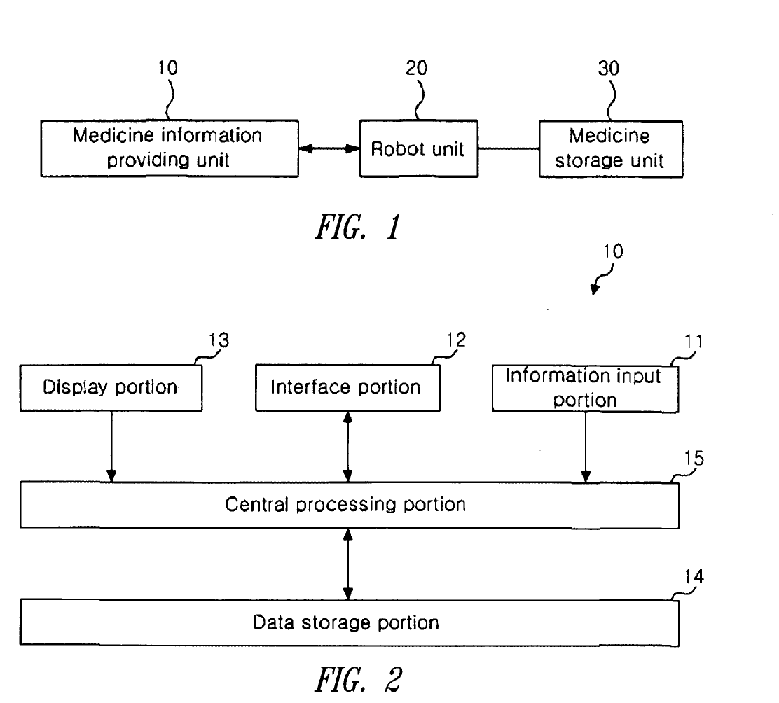

A system for taking out medicines according to an embodiment of the present invention will be described in detail below with reference to FIGS. 1 to 3.

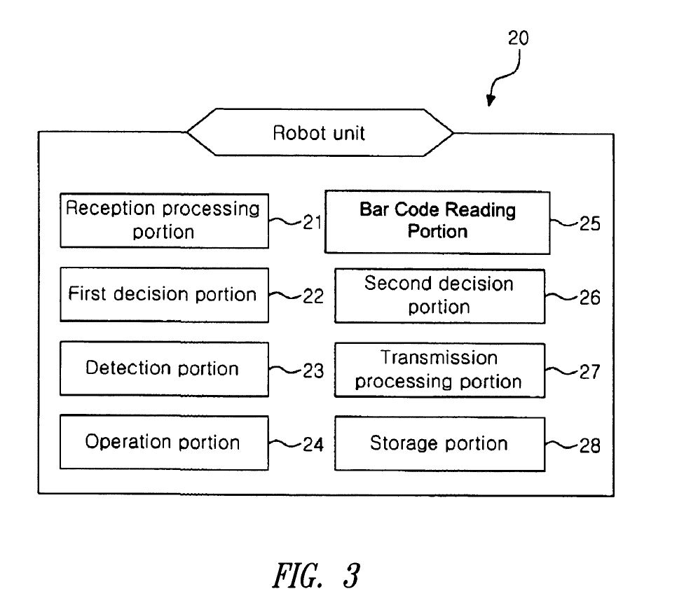

FIG. 1 is a block diagram illustrating a system for taking out medicines according to an embodiment of the present invention, FIG. 2 is a block diagram illustrating a medicine information providing unit shown in FIG. 1, and FIG. 3 is a block diagram illustrating a robot unit shown in FIG. 1.

Referring to FIG. 1, the system for taking out medicines according to the present invention comprises a medicine storage unit 30 for storing medicines; a medicine information providing unit 10 for transmitting medicine information on a medicine to be used for preparation; and a robot unit 20 for taking out a medicine, which corresponds to medicine information received from the medicine information providing unit 10, from the medicine storage unit 30 and subsequently moving the medicine to a predetermined position. At this time, bar codes for representing medicine information are attached to medicines stored in the medicine storage unit 30.

The medicines that have been stored in the medicine storage unit 30 are special tablet system (STS) medicines, and thus, they are medicines that are not to be held in cassettes of an automatic tablet dispensing and packaging system (ATDPS). The STS medicines include, for example, medicine cases in which expensive tablets or tablets that are not frequently used are held, cases in which ointments are accommodated, and the like.

Referring to FIG. 2, the medicine information providing unit 10 comprises an information input portion 11 for inputting information so that services related to the present invention can be performed; an interface portion 12 for transmitting and receiving the information related to the present invention; a display portion 13 for displaying the information related to the present invention; a data storage portion 14 for storing the information related to the present invention; and a central processing portion 15 for transmitting medicine information on a medicine to be used for preparation to the robot unit 20 or monitoring the operation status of the robot unit 20.

The information input portion 11 is a means for inputting medicine information on a medicine to be used for preparation. In particular, the information input portion 11 receives medicine information on a medicine which cannot be easily packaged dosage by dosage through the ATDPS.

Furthermore, the information input portion 11 receives not only medicine information on a medicine to be used for preparation but also control instructions for causing the received medicine information to be transmitted to the robot unit 20.

The interface portion 12 communicates with the robot unit 20 to transmit the medicine information to the robot unit 20 or to provide the central processing portion 15 with the information received from the robot unit 20.

The data storage portion 14 stores the medicine information received from the information input portion 11. Furthermore, the data storage portion 14 temporarily stores the operation status received from the robot unit 20.

The central processing portion 15 causes the medicine information received through the information input portion 11 to be transmitted to the robot unit 20 through the interface portion 12.

Although the medicine information has been described as being transmitted to the robot unit 20 in this embodiment, the present invention is not limited thereto. That is, information on a position where a medicine is located as well as the medicine information may be transmitted. However, it is preferred that the medicine information and the position information be transmitted when the robot unit 20 stores only medicine information on medicines which have been stored in the medicine storage unit 30.

First, the external configuration of the robot unit 20 will be described below. The robot unit 20 comprises a body (not shown), a robot arm (not shown) mounted movably in an up and down direction on the body, a gripper (not shown) for gripping and taking out a medicine; and a moving means (not shown) for moving to a predetermined position along a predetermined robot moving line. At this time, the gripper has a rotatable structure, and the moving means is, for example, an automatic guided vehicle (AGV).

As for the interior configuration of the robot unit 20, the robot unit 20 comprises a reception processing portion 21, a first decision portion 22, a detection portion 23, an operation portion 24, a bar cord reading portion 25, a second decision portion 26, a transmission processing portion 27, and a storage portion 28.

The storage portion 28 stores not only the medicine information (for example, Festal™, MagMil™, etc.) for identifying medicines which have been stored in the medicine storage unit 30 but also the position information on the medicines.

Although the medicine information for identifying medicines has been described as being medicine names in this embodiment, the present invention is not limited thereto.

Further, although the robot unit 20 has been described as including the storage portion 28 in this embodiment, the present invention is not limited thereto.

The reception processing portion 21 receives medicine information on a medicine to be used for preparation from the medicine information providing unit 10.

The first decision portion 22 determines whether the storage portion 28 has stored medicine information that is identical to that received by the reception processing portion 21. That is, the first decision portion 22 determines whether the received medicine information is medicine information on a medicine that has been stored in the medicine storage unit 30.

If it is determined by the first decision portion 22 that the storage portion 28 has stored the medicine information which is identical to the received medicine information, the detection portion 23 detects position information on a medicine corresponding to the received medicine information from the storage portion 28. At this time, the storage portion 28 stores the medicine information on the medicine and the position information on the medicine stored in the medicine storage unit 30.

The operation portion 24 causes the robot unit to move to the position of the corresponding medicine along the predetermined robot moving line based on the position information detected by the detection portion 23, and then adjusts the robot arm to take out the corresponding medicine at the moved position.

Further, the operation portion 24 causes the taken-out medicine to move to a predetermined position. At this time, it is preferred that the predetermined position be set as a position where a pharmacist can conveniently receive the taken-out medicine.

The bar code reading portion 25 reads out a bar code attached to the medicine which has been stored in the medicine storage unit 30. At this time, the bar code has information recorded to represent medicine information on the corresponding medicine.

More specifically, the operation portion 24 causes the robot unit 20 to move to the position of the corresponding medicine along the predetermined robot moving line, and then the bar cord reading portion 25 reads out the bar code attached to the corresponding medicine.

The second decision portion 26 determines whether the medicine information read by the bar cord reading portion 25 is identical to that received from the medicine information providing unit 10. Accordingly, by reading out the bar code attached to the medicine which has been stored in the medicine storage unit 30, it is possible to exactly determines the medicine that corresponds to the medicine information received from the medicine information providing unit 10.

In this embodiment, when it is determined by the first decision portion 22 that the storage portion 28 has stored medicine information which is identical to that received from the medicine information providing unit 10, the corresponding medicine may be taken out and then moved to the predetermined position. Otherwise, when all the conditions of the first decision portion 22 and the second decision portion 26 are satisfied, the corresponding medicine may be taken out and then moved to the predetermined position.

If it is determined by the first decision portion 22 that the storage portion 28 does not have stored medicine information which is identical to that received from the medicine information providing unit 10, the transmission processing portion 27 transmits a predetermined error message to the medicine information providing unit 10. Accordingly, a pharmacist or manager can easily recognize that the medicine to be used for preparation has not been stored in the medicine storage unit 30 or there is an error in the medicine information transmitted to the robot unit 20.

Further, even when it is determined by the second decision portion 26 that the medicine information read by the bar cord reading portion 25 is not identical to that received from the medicine information providing unit 10, the transmission processing portion 27 transmits a predetermined error message to the medicine information providing unit 10.

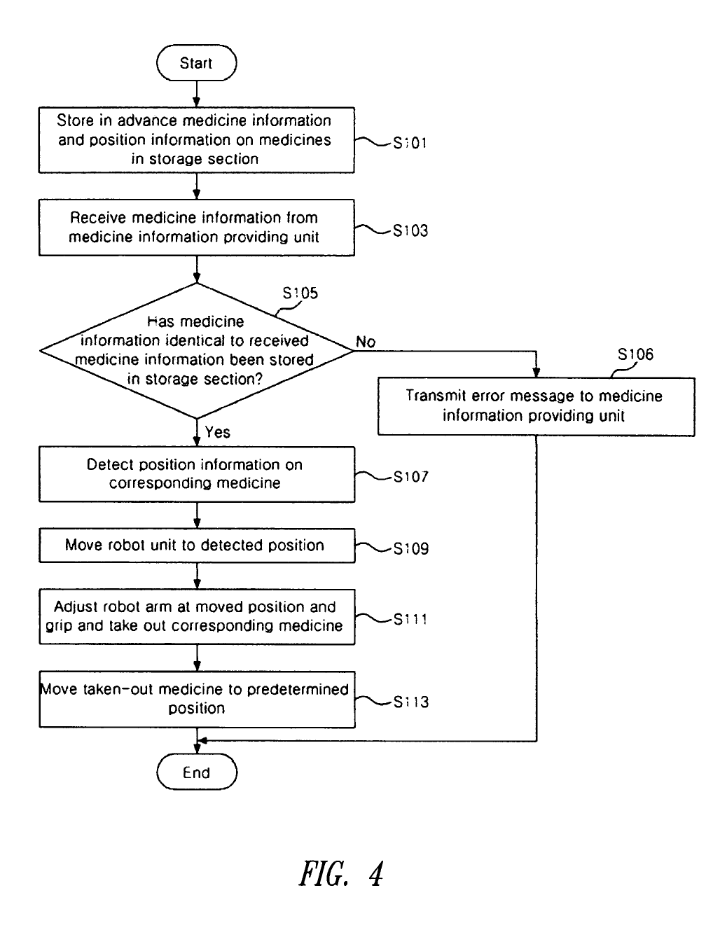

A method for taking out medicines in the system for taking out medicines constructed as above will be described below with reference to FIG. 4.

The robot unit 20 has already caused medicine information on medicines, which have been stored in the medicine storage unit 30, as well as position information on the medicines to be stored in the storage portion 28 (S101).

Then, the reception processing portion 21 of the robot unit 20 receives medicine information on a medicine to be used for preparation from the medicine information providing unit 10 (S103).

Although the medicine information received from the medicine information providing unit 10 has been described as being medicine information on a medicine to be used for preparation in this embodiment, the present invention is not limited thereto.

Then, the first decision portion 22 of the robot unit 20 determines whether the storage portion 28 has stored medicine information which is identical to the received medicine information (S105).

If it is determined in step S105 that the storage portion 28 does not have stored medicine information which is identical to the received medicine information, the transmission processing portion 27 of the robot unit 20 transmits a predetermined error message to the medicine information providing unit 10 (S106).

If it is determined in step S105 that the storage portion 28 has stored medicine information which is identical to the received medicine information, i.e., if the medicine storage unit 30 stores a medicine corresponding to the received medicine information, the detection portion 23 of the robot unit 20 detects position information on the medicine corresponding to the received medicine information from the storage portion 28 (S107).

Then, the operation portion 24 of the robot unit 20 causes the robot unit 20 to move to the detected position (S109). That is, the operation portion 24 causes the robot unit 20 to move to the position where the corresponding medicine is stored in the medicine storage unit 30 along the predetermined robot moving line (S109).

Then, the operation portion 24 adjusts the robot arm at the moved position to grip and take out the corresponding medicine (S111).

Next, the operation portion 24 moves the taken-out medicine to a predetermined position (S113).

By doing so, a pharmacist can conveniently receive the medicine to be used for preparation and then quickly perform preparation.

In this embodiment, the corresponding medicine has been described as being taken out and moved to the predetermined position after step S109. However, in another embodiment, after step S109, the robot arm may be adjusted at the moved position to read a bar code attached to the corresponding medicine, and it may be then determined whether the medicine information of the read bar code is identical to the medicine information received from the medicine information providing unit 10, so that the corresponding medicine is taken out and moved to the predetermined position if it is determined that the medicine information of the read bar code is identical to the received medicine information.

Furthermore, in this embodiment, the storage portion 28 of the robot unit 20 has been described as storing medicine information on medicines as well as position information on the medicines. However, in another embodiment, the robot unit 20 that has received from the medicine information providing unit 10 the medicine information on the medicine to be used for preparation as well as the position information on the medicine stored in the medicine storage unit 30 may take out the corresponding medicine and then move the medicine to the predetermined position.

According to the present invention described above, the robot unit is used to take out a medicine, which corresponds to medicine information received from the medicine information providing unit, from the medicine storage unit and to move the taken-out medicine to a predetermined position. Thus, there is an advantage in that it is possible to overcome inconvenience in which a pharmacist should directly find a medicine to be used for preparation. Furthermore, there is another advantage in that it is possible to overcome a waste of time consumed to find a medicine to be used for preparation.

Furthermore, according to the present invention described above, a bar code attached to a corresponding medicine which has been stored in the medicine storage unit is read. Thus, there is an advantage in that it is possible to verify whether information of the read bar code is identical to medicine information received from the medicine information providing unit. Accordingly, since the verified medicine can be transmitted to a pharmacist, the accuracy of the medicine to be used for preparation can be improved.

In addition, according to the present invention described above, if the storage portion dose not have stored medicine information received from the medicine information providing unit, a predetermined error message is transmitted to the medicine information providing unit. Thus, there is an advantage in that a pharmacist or manager can quickly recognize a response of the robot unit to a medicine to be used for preparation.

The present invention is not limited to the embodiments described above, and it will be apparent to those skilled in the art that various modifications and changes can be made thereto and fall within the spirit and scope of the invention defined by the appended claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system for taking out medicines, comprising:
a medicine storage unit for storing medicines;
a medicine information providing unit for transmitting at least one piece of medicine information;
a storage portion for storing medicine information on the medicines stored in the medicine storage unit as well as position information on the medicines; and
a robot unit for taking out a corresponding medicine from the medicine storage unit and moving the taken-out medicine to a predetermined position if the storage portion has stored medicine information which is identical to medicine information received from the medicine information providing unit.

2. The system as claimed in claim 1, wherein the robot unit includes:
a reception processing portion for receiving the medicine information from the medicine information providing unit;
a first decision portion for determining whether the storage portion has stored the medicine information which is identical to the received medicine information;
a detection portion for detecting position information on the corresponding medicine from the storage portion if it is determined that the storage portion has stored the medicine information which is identical to the received medicine information; and
an operation portion for moving the robot unit to the detected position to take out the corresponding medicine.

3. The system as claimed in claim 2, wherein bar codes for representing medicine information are attached to the medicines stored in the medicine storage unit, and
the robot unit further includes:
a bar code reading portion for reading the bar code attached to the corresponding medicine; and
a second decision portion for determining whether the received medicine information is identical to medicine information of the read bar code.

4. The system as claimed in claim 2, wherein the robot unit further includes a transmission processing portion for transmitting an error message to the medicine information providing unit if the storage portion does not store medicine information which is identical to the received medicine information.

5. A method for taking out medicines in a system for taking out medicines including a medicine storage unit for storing medicines, a medicine information providing unit for transmitting at least one piece of medicine information, and a robot unit for receiving medicine information from the medicine information providing unit and taking out medicines from the medicine storage unit, the method comprising the steps of:
receiving the medicine information from the medicine information providing unit;
determining whether a storage portion has stored the received medicine information;
if it is determined that the storage portion has stored the medicine information which is identical to the received medicine information, detecting position information on a corresponding medicine from the storage portion;
moving the robot unit to the detected position and taking out the corresponding medicine; and
moving the taken-out medicine to a predetermined position.

6. The method as claimed in claim 5, wherein bar codes for representing medicine information are attached to the medicines stored in the medicine storage unit, and
the method further comprises, after the detecting step, the steps of:
moving the robot unit to the detected position and reading the bar code attached to the corresponding medicines, and
determining whether the received medicine information is identical to the medicine information of the read bar code.

7. The method as claimed in claim 5, after the determining step, further comprising the step of:
if the storage portion does not have stored medicine information which is identical to the received medicine information, transmitting an error message to the medicine information providing unit.
